(19) United States
(12) Patent Application Publication
(10) Pub. No.: US 2011/0300855 A1
(43) Pub. Date: Dec. 8, 2011

(54) METHOD FOR SUPPORTING AN OPERATIONAL WIRELESS CONNECTION OF A MOBILE STATION TO A MACROCELL OR FEMTOCELL BASE STATION

(75) Inventors: Jun Zhou, London (GB); Linghang Fan, Surrey (GB); Nader Zein, London (GB)

(73) Assignee: NEC EUROPE LTD., Heidelberg (DE)

(21) Appl. No.: 13/201,569

(22) PCT Filed: Mar. 1, 2010
(86) PCT No.: PCT/EP2010/001244

§ 371 Date: Aug. 15, 2011

(30) Foreign Application Priority Data
Feb. 27, 2009 (EP) 09250559.3

(51) Int. Cl. H04W 4/00

(52) U.S. Cl. 455/422.1

(57) ABSTRACT

A method for supporting an operational wireless connection of a mobile station to a macrocell or femtocell base station—current base station—, wherein the mobile station is located both within the coverage area of the current base station and in the coverage area of another base station—foreign base station—, in particular a femtocell base station, wherein the mobile station has access authorization to the current base station and no access authorization to the foreign base station, is characterized in that a restricted connection is permitted between the mobile station and the foreign base station.

The present invention relates to a method for supporting an operational wireless connection of a mobile station to a macrocell or femtocell base station—current base station—, wherein said mobile station is located both within the coverage area of said current base station and in the coverage area of another base station—foreign base station—, in particular a femtocell base station, wherein said mobile station has access authorisation to said current base station and no access authorisation to said foreign base station.

There is currently an interest from mobile network operators to deploy so called femtocells (also known as home base stations, home BTS, picocells, home NBs, femto access points (FAPs), or femto radio base stations) which would be installed within the homes of the operators' customers. Such femtocells, currently being developed and standardized for both 3G and 4G networks, are scaled-down low-cost mobile base stations with low transmit power. Installation of femtocell base stations will typically be handled by the customers themselves without any technical training, therefore it has to be a simple plug-and-play procedure. Femtocell base stations are similar to a WiFi Access Point, but the radio interface is based on wide area cellular network standards such as WiMAX (Worldwide Interoperability for Microwave Access), UMTS (Universal Mobile Telecommunications System) or 3GPP LTE (Long Term Evolution). Femtocell base stations are connected to the operators' network via a virtual private network connection over a normal broadband internet connection—backhaul connection—like DSL or FTTH (Fiber to the home).

One reason for the introduction of femtocells is the increase of operator network coverage and throughput for the sake of a better user experience and therewith to make a big step towards fixed-mobile-convergence. Like Wi-Fi access points, femtocells are designed to be deployed in home and office environments in order to give full coverage in the respective area and deployment of high density is expected in areas with high population or office density. However, the deployment of femtocells comes along with drawbacks of which one is interference effects between macro and femto levels of the network. Since femtocell base stations are often deployed in the same licensed spectrum as the wide area network of the operator, it is important to configure the radio interface correctly to avoid interference with other base stations.

Femtocell networks can improve indoor coverage and capacity. However, a femtocell base station needs to carefully balance its transmit power, which should be high enough to ensure good signal strengths for its subscribers, but not too high to avoid severe interference to other mobile stations, other femtocells and possible co-located macrocell base stations. To address this problem, according to prior art solutions femtocells for example are linked to the network's Radio Resource Management (RRM), which is a functional/logical unit that is typically located in the Radio Access Network and that is responsible e.g. for frequency allocation and controlling the transmit power.

Furthermore, the owner of the backhaul connection and/or the femtocell base station may want to restrict access to the femtocell base station because he pays the expense of maintenance and the broadband connection to his premises. For example, a closed subscriber group (CSG) femtocell base station—referred to as CSG-Closed—is defined in the IEEE 802.16m, and, except for emergency services, it is accessible only those mobile stations that are members of this base station. The problem is that in this case, mobile stations that are within the coverage area of a femtocell base station but are not members of this femtocell will suffer strong interference and may not keep qualified connection with its own macrocell base station or femtocell base station. In a worst case scenario the interference could be so severe that the access to the network may be completely blocked for the affected mobile station. The network will not have any information about the cause for the lack of connectivity of the affected mobile station and cannot take corrective measure to reconnect the mobile station.

It is therefore an object of the present invention to improve and further develop a method of the initially described type for supporting an operational wireless connection of a mobile station to a macrocell or femtocell base station in such a way that, by employing mechanisms that are readily to implement, interference of the mobile station in the coverage of wireless network systems is reduced.

In accordance with the invention, the aforementioned object is accomplished by a method comprising the features of claim 1. According to this claim such a method is characterized in that a restricted connection is permitted between said mobile station and said foreign base station.

The invention takes into consideration that a mobile station located within the coverage area of a foreign base station and having no access authorisation to this foreign base station will suffer and/or cause strong interference from and/or to this foreign base station. In this context, according to the invention it has first been recognized that the mobile station which has no access authorisation requires a special attention by the foreign base station. Specifically, it has been recognized that interference can be reduced by permitting a restricted connection between the mobile station and the foreign base station. The restricted connection may be used to notify information regarding interference that the mobile station is suffering and/or causing. Thereupon appropriate measures may be induced to mitigate or avoid the interference. Thus, the mobile station is not excluded from the network and thereby a significant enhancement of connectivity of the mobile station is achieved. The restricted connection gives the mobile station without access authorisation the chance/means to access the wireless network by using very little radio resources of the foreign base station and to launch a process which tries to mitigate the interference. Both current base station and foreign base station may be used to provide access for the mobile station to the mobile operator's network and its services. Thereby, the method according to the invention increases the QoS (Quality of Service) of the mobile station when the mobile station goes into the coverage area of the foreign base station.

The method according to the invention can be suitably applied, for instance, in cellular technologies such as UMTS and WiMAX. However, it is to be understood that the invention is applicable in any wireless access network with admission control, for example for various kinds of mesh networks or ad-hoc networks, as well as different radio systems such as DECT (Digital Enhanced Cordless Telecommunications) or systems according to the IEEE 802.11.

According to a preferred embodiment the restricted connection may be granted to the mobile station upon the mobile station registering itself to the foreign base station. Thus, when an active mobile station without access authorisation is in the coverage area of a foreign base station, it can register itself to this foreign base station which will qualify the mobile station as a non-member mobile station and will grant restricted access. For instance, a non-member mobile station may register itself to a foreign base station under certain conditions, e.g. if the mobile station is under severe interference from the foreign base station.

According to a preferred embodiment the restricted connection may be realized in such a way that only the transmission—sending and/or receiving—of signaling information is permitted. This means that the restricted connection cannot be used for the transmission—sending and/or receiving—of traffic data for non-member mobile stations. Thereby, it is provided that the mobile station suffering severe interference conditions may communicate with the network through the foreign base station and pass information about its signal conditions in order to reduce the interference.

In particular, the signaling information which is permitted to be transmitted via the restricted connection may be used to inform the operator's network of the radio conditions in the neighborhood of the mobile station.

With respect to maintaining connectivity and access to the network and its services, the signaling information permitted to be transmitted via the restricted connection may be employed for reducing interference and/or invoking reconfiguration of the mobile station. Thus, the configuration of the mobile station may be adapted to the situation regarding interference conditions.

Advantageously, the signaling information permitted to be transmitted via the restricted connection may be employed by the foreign base station to negotiate the allocation of radio resources with the current base station.

In particular, based on the signaling information the allocation of radio resources may be carried out and/or managed by the foreign base station, the current base station and/or a radio resource management (RRM) server. This allows additional radio resource management in such a way that non-member mobile stations can have less interference to access the public/macro network and/or the wireless access can be made more efficient.

To improve and optimize the handling of the mobile station, the signaling information permitted to be transmitted via the restricted connection may include information regarding channel state, spectrum resource used by mobile stations and/or power level of received interference.

For the uplink transmission, the signaling information permitted to be transmitted via the restricted connection may be used by the foreign base station to cancel the interference from non-member mobile stations.

Advantageously, the interference may be reduced by deploying interference mitigation techniques which include Advanced Antenna Systems, in particular beamforming, power control, spectrum avoidance, etc. The foreign base station may use these interference techniques for the downlink transmission to reduce the interference to the non-member mobile station based on the signaling information provided by the non-member mobile station.

Advantageously, the foreign base station administrates a member list that may include all mobile stations—member mobile stations—that have access authorisation to the foreign base station. Particularly, the member list may include the status of the member mobile stations.

According to a preferred embodiment, the foreign base station administrates a non-member list that may include active mobile stations—non-member mobile stations—that are located in the coverage area of the foreign base station and do not have access authorisation to the foreign base station. Consequently, the non-member list may include any active mobile station in the coverage area of the foreign base station that is not a member of the foreign femtocell base station. One mobile station may be included in the non-member list of several femtocell base stations since the coverage area of femtocells may overlap.

In particular with respect to an effective administration of the non-member list, a non-member mobile station may be removed from the non-member list when it becomes inactive or gets out of reach of the foreign base station.

Advantageously, the foreign base station may inform the current base station about its spare and/or idle radio resources. Thus, the current base station of the mobile station is enabled to obtain information regarding the resources that are not used by the foreign base station.

With respect to an improvement overall network performance all or a part of the unused radio resources—idle radio resources—of the foreign base station may be allocated to the mobile station.

There are several ways how to design and further develop the teaching of the present invention in an advantageous way. To this end, it is to be referred to the patent claims subordinate to patent claim 1 on the one hand, and to the following explanation of preferred examples of embodiments of the invention illustrated by the drawings on the other hand. In connection with the explanation of the preferred example of an embodiment of the invention by the aid of the drawings, generally preferred embodiments and further developments of the teaching will be explained. In the drawings

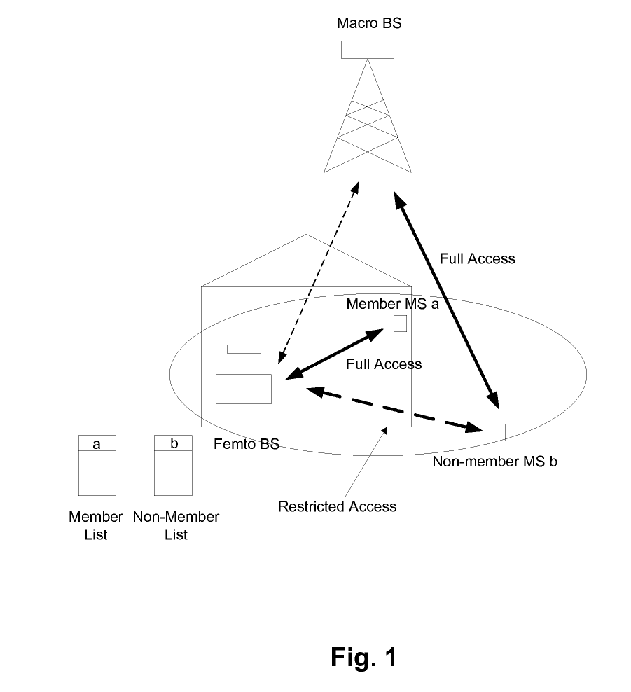

FIG. 1 is a schematic view illustrating an example of an application scenario of a method according to the present invention,

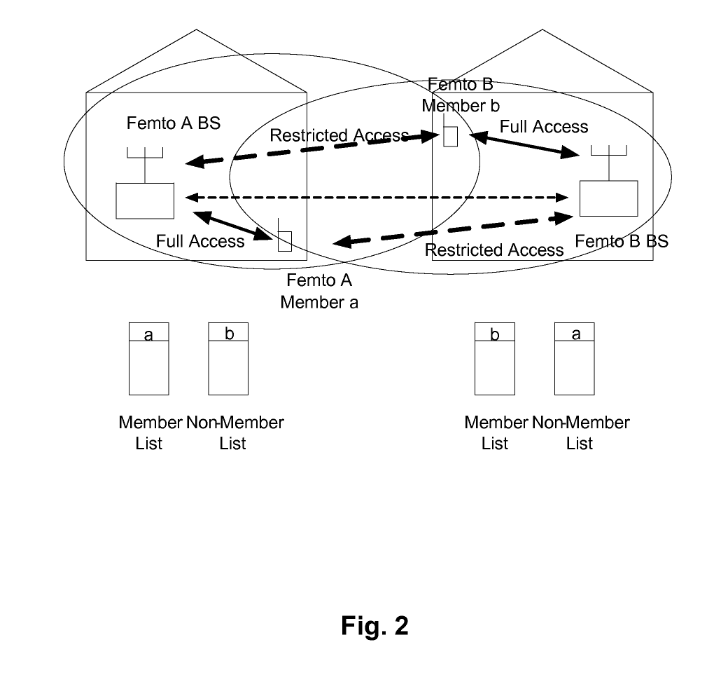

FIG. 2 is a schematic view of an example of another application scenario of a method according to the present invention illustrating two femtocells with overlapping coverage areas, and

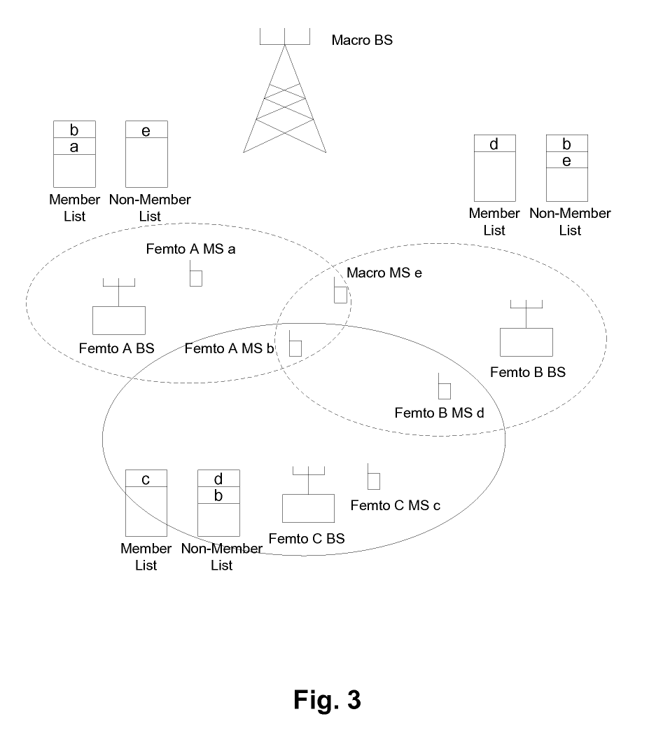

FIG. 3 is a schematic view of an example of another application scenario of a method according to the present invention illustrating a macrocell and multiple femtocells with overlapping coverage areas.

FIG. 1 shows a schematic view illustrating an application scenario in the context of celluar networks. In the illustrated embodiment, a femtocell base station, in the following referred to as Femto BS, is installed in an indoor environment. The coverage area of the Femto BS is indicated in an idealized fashion by the elliptic curve. Both a mobile station—Member MS a—having access authorisation to the Femto BS and a mobile station—Non-member MS b—having no access authorisation to the Femto BS are located in the coverage area of the Femto BS.

In the embodiment illustrated in FIG. 1, it is assumed that the Femto BS is operated by using the concept of a closed subscriber group (CSG) such that the Femto BS allows only members to access its services. Based thereon, the Femto BS maintains two lists; one is the member list, which includes all members of the closed subscriber group of the Femto BS and the status of each member; and the other is the non-member list which includes any active mobile station located in the coverage area of the Femto BS that is not a member of the Femto BS.

The Member MS a, as a member of the closed subscriber group, has full access to the Femto BS, whereas the Non-member MS b has—initially—no access to the Femto BS. However, the Non-member MS b has full access to the macrocell base station—Macro BS—, which is referred to as current macrocell base station and wants to keep a qualified connection to the Macro BS.

Once the Non-member MS b is in the coverage area of the Femto BS and its status is active, it registers itself to the Femto BS as non-member according to its access right and is included in the non-member list of the Femto BS. Upon inclusion into the non-member list, the Non-member MS b is granted restricted access and connection to the Femto BS. This restricted connection is used to transmit—send and/or receive—signaling information for interference mitigation purpose. However, the restricted connection is established in such a way that it cannot be used by the Non-member MS b to transmit or receive any traffic data. The signaling information includes for example channel state information, spectrum resource used by the mobile stations, power level of received interference, etc.

For the downlink transmission, the Femto BS can use interference mitigation techniques to reduce the interference to the Non-member MS b based on the signalling information permitted to be transmitted via the restricted connection and provided by the Non-member MS b. These technologies may include Advanced Antenna Systems such as beamforming, power control, spectrum avoidance, etc.

For the uplink transmission, this information may be used for the Femto BS to cancel the interference from the Non-member MS b. The Femto BS may also inform the Macro BS and/or the Non-member MS b about its spare resources that are not used by the Femto BS, thus the unused resource can be allocated to the Non-member MS b without causing severe interference. The Femto BS may also negotiate with the Macro BS base station of the Non-member MS b about the allocation of resources to optimise the overall network performance.

FIG. 2 shows a schematic view illustrating an application scenario with two femtocell base stations—Femto BS A and Femto BS B—in which the coverage areas of the femtocell base stations overlap. Each of the two femtocell base stations administrates an own member list and an own non-member list. The mobile station Femto A Member a is a member of Femto BS A and a non-member of Femto BS B. In contrast, the mobile station Femto B Member b is a member of Femto BS B and a non-member of Femto BS A. Furthermore, the mobile stations Femto A Member a and Femto B Member b are located both in the coverage area of Femto BS A and in the coverage area of Femto BS B. The interference caused by the overlapping of both femtocells is reduced for both mobile stations by permitting a restricted connection to the respective foreign femtocell base station. Thus, the performance of the femtocells is enhanced when the coverage areas of independent femtocell base stations overlap because the mobile station which is a member of one femtocell base station may be on the non-member list of another femtocell base station and thereby the interference between these two femtocell base stations may decrease.

FIG. 3 shows a schematic view of an example of an application scenario in which a macrocell and three femtocell base stations with overlapping coverage areas are illustrated. The operation mode of the method according to the present invention is analog to the embodiments described in connection with FIGS. 1 and 2. FIG. 3 additionally illustrates that one mobile station may be included in the non-member list of several femtocell base stations since the coverage area of femtocells may have overlap.

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. Method for supporting an operational wireless connection of a mobile station to a macrocell or femtocell base station—current base station—, wherein said mobile station is located both within the coverage area of said current base station and in the coverage area of another base station—foreign base station—, in particular a femtocell base station, wherein said mobile station has access authorisation to said current base station and no access authorisation to said foreign base station, characterized i n that a restricted connection is permitted between said mobile station and said foreign base station.

2. Method according to claim 1, wherein said restricted connection is granted to said mobile station upon said mobile station registering itself to said foreign base station.

3. Method according to claim 1, wherein said restricted connection is realized in such a way that only the transmission—sending and/or receiving—of signaling information is permitted.

4. Method according to claim 1, wherein signaling information being used to inform the operator's network of the radio conditions in the neighborhood of said mobile station is permitted to be transmitted via said restricted connection.

5. Method according to claim 1, wherein signaling information being employed for reducing interference and/or invoking reconfiguration of said mobile station is permitted to be transmitted via said restricted connection.

6. Method according to claim 1, wherein signaling information being employed by said foreign base station to negotiate the allocation of radio resources with said current base station is permitted to be transmitted via said restricted connection.

7. Method according to claim 1, wherein the allocation of radio resources is carried out and/or managed by said foreign base station, said current base station and/or a radio resource management server based on signaling information permitted to be transmitted via said restricted connection.

8. Method according to claim 1, wherein signaling information including information regarding channel state, spectrum resource used by mobile stations and/or power level of received interference is permitted to be transmitted via said restricted connection.

9. Method according to claim 1, wherein interference is reduced by deploying interference mitigation techniques including Advanced Antenna Systems, in particular beamforming, power control and/or spectrum avoidance.

10. Method according to claim 1, wherein said foreign base station administrates a member list that includes mobile stations—member mobile stations—that have access authorisation to said foreign base station.

11. Method according to claim 10, wherein said member list includes the status of said member mobile stations.

12. Method according to claim 1, wherein said foreign base station administrates a non-member list that includes active mobile stations—non-member mobile stations—that are located in the coverage area of said foreign base station and do not have access authorisation to said foreign base station.

13. Method according to claim 12, wherein a non-member mobile station is removed from said non-member list when it becomes inactive or leaves the coverage area of said foreign base station.

14. Method according to claim 1, wherein said foreign base station informs said current base station about its idle radio resources.

15. Method according to claim 14, wherein all or a part of said idle radio resources are allocated to said mobile station.

16. Method according to claim 2, wherein said restricted connection is realized in such a way that only the transmission—sending and/or receiving—of signaling information is permitted.
